(19) United States
(12) Patent Application Publication
(10) Pub. No.: US 2026/0029631 A1
(43) Pub. Date: Jan. 29, 2026

(54) Apparatus and Method for Light Field Microscopy

(71) Applicant: Carl Zeiss Microscopy GmbH, Jena (DE)

(72) Inventors: Tiemo Anhut, Jena (DE); Daniel Schwedt, Weimar (DE); Joerg Steinert, Jena (DE); Matthias Wald, Jena (DE)

(21) Appl. No.: 18/874,624

(22) PCT Filed: Jun. 11, 2023
(86) PCT No.: PCT/EP2023/065561

§ 371 Date: Oct. 14, 2025

(30) Foreign Application Priority Data
Jun. 14, 2022 (DE) 10 2022 114 984.6

(51) Int. Cl. G02B 21/00; G01N 21/64; G06T 17/00

(52) U.S. Cl. CPC G02B 21/0076; G01N 21/6458; G06T 17/00; G01N 2021/6463

(57) ABSTRACT

A device for light field microscopy, comprising: a two-dimensionally spatially resolving detector for detecting light radiated by a sample; a detection beam path having at least one microscope objective lens; and at least one multi-lens array for imaging the light radiated by the sample onto the detector, wherein the multi-lens array is arranged in a plane which is optically conjugated with respect to a rear focal plane of the microscope objective lens, or in the vicinity of such a plane; and a control and evaluation unit for activating the detector and for evaluating the measurement data from the detector. The device also includes an adjustable relay optical system in order to image the rear focal plane of the microscope objective lens into the plane in which the multi-lens array is arranged, or in the vicinity of this plane. A method for light field microscopy is also provided.

The present invention relates in a first aspect to an apparatus according to the preamble of claim 1 for light field microscopy and in a second aspect to a method of light field microscopy according to the preamble of claim 30.

A generic apparatus for light field microscopy comprises the following components: a light source for transmitting excitation light, an illumination beam path for guiding the excitation light onto or into a sample, a two-dimensionally spatially resolving detector for detecting light emitted by the sample, and a detection beam path containing at least one microscope objective and containing at least one multi-lens array for imaging the light emitted by the sample onto the detector. The multi-lens array is arranged in a plane optically conjugate to the back focal plane of the microscope objective, or in the vicinity of such a plane. Finally, there is a control and evaluation unit present, at least for controlling the detector and for evaluating the measurement data from the detector.

In a generic method of light field microscopy, the following steps are carried out: a sample is irradiated with excitation light, and light emitted by the sample is imaged via a microscope objective and a multi-lens array onto a two-dimensionally spatially resolving detector. The multi-lens array is arranged in a plane optically conjugate to the back focal plane of the microscope objective, or in the vicinity of such a plane. Finally, a three-dimensional image of the sample is reconstructed from an image recorded by the detector.

A generic apparatus and a generic method are described in vol. 27, no. 18/Sep. 2, 2019/Optics Express 25573.

In modern biomedical research, processes in living samples are increasingly being investigated microscopically. This requires simultaneous recording of the signals in all three dimensions of the sample. It is often also of interest here to modify the size of the observed field and adjust the magnification of the microscope accordingly. Light field microscopy has been increasingly discussed in recent years for simultaneous three-dimensional fluorescence microscopy. In this context, a multi-lens array in front of the camera is used to simultaneously record location and angle information in a single camera image, and so the volume information can be inferred from this data.

In principle, the entire field of view transmitted by the objective can be used. However, the resolving power of a light field microscope is reduced on account of the quasi four-dimensional (two linear coordinates, two angular coordinates) division of the camera chip. Therefore, it may be advantageous to bring about a change in the resolution by switching the microscope objective. So-called Fourier light field microscopy has turned out to be a variant of light field detection that is preferred for microscopy. In this case, the multi-lens array is introduced into a plane conjugate to the back focal plane of the microscope objective. A multiplicity of real images, each corresponding to a different viewing direction onto the sample, are then created on the camera chip. The object-side numerical aperture (NA) in each individual partial image is reduced in accordance with the number of lenses in the multi-lens array, whereby the depth of field of the microscope is increased but the resolution is reduced. However, the axial position of the reference plane, specifically that of the back focal plane of the microscope objective, is usually modified in the system in the event of a switch of the microscope objective. Moreover, the diameter of the pupil boundary generally changes. This may result in a modified illumination of the multi-lens array, whereby lenses of the multi-lens array located at the pupil edge might no longer be fully illuminated, in other words be curtailed. As a result, their point spread function (PSF) may be severely affected, and so the associated measurement data might not be usable under certain circumstances.

A problem addressed by the present invention can be considered to be that of developing an apparatus for light field microscopy and a method of light field microscopy, of the aforementioned type, which allow a magnification to be set and the resolution of a light field microscope to be optimized.

This problem is solved by the apparatus having the features of claim 1 and by the method having the features of claim 30.

According to the invention, the apparatus of the aforementioned type is developed in that there is an adjustable relay optical unit present for imaging the back focal plane of the microscope objective into the plane in which the multi-lens array is arranged, or into the vicinity of this plane.

According to the invention, the method of the aforementioned type is developed in that the back focal plane of the microscope objective is imaged by an adjustable relay optical unit with variable magnification into the plane in which the multi-lens array is arranged, or into the vicinity of this plane.

Advantageous exemplary embodiments of the apparatus according to the invention and preferred variants of the method according to the invention are explained below, in particular in association with the dependent claims and the attached figure.

The provision of a variable optical unit for imaging a back focal plane of the microscope objective into the plane in which the multi-lens array is arranged can be considered to be an essential concept of the present invention. The apparatus according to the invention for light field microscopy can thus be operated both with different microscope objectives and, when using one and the same microscope objective, in different method variants.

The present invention thus permits considerable extensions of the functionality of the apparatus for light field microscopy. Aberrations due to incorrect illumination of the lens array can be avoided in the apparatus according to the invention and in the method according to the invention.

The excitation light is electromagnetic radiation, in particular in the visible spectral range and adjoining ranges. The only demand placed on the contrast-providing principle by the present invention is that the sample emits emission light as a consequence of the irradiation by the excitation light and/or deflects, scatters or reflects back the excitation light. Typically, the emission light is fluorescence which the sample, in particular dye molecules present there, emits or emit as a consequence of the irradiation by the excitation light.

At least one light source, for example a laser, is present for the provision of the excitation light. The spectral composition of the excitation light can be adjustable, in particular between two or more colors. The excitation light can also simultaneously be polychromatic, for example if different dyes are intended to be detected simultaneously.

The term “illumination beam path” denotes all optical beam-guiding and beam-modifying components, for example lenses, mirrors, prisms, gratings, filters, stops, beam splitters, modulators, e.g. spatial light modulators (SLM), by means of which and via which the excitation light from the light source is guided to the sample to be examined.

Light that is emitted and/or deflected, for example scattered and generally radiated, by the sample to be examined as a consequence of the irradiation by the excitation light can be referred to as emission light and reaches the camera via the detection beam path. The term “detection beam path” denotes all beam-guiding and beam-modifying optical components, for example lenses, mirrors, prisms, gratings, filters, stops, beam splitters, modulators, e.g. spatial light modulators (SLM), by means of which and via which the emission light is guided from the sample to be examined to the detector. In particular, the microscope objective and the multi-lens array are part of the detection beam path.

The term “point spread function” of a lens, for example a lens of the multi-lens array, refers to the intensity distribution of the light created by the lens from an incoming parallel beam that fills the effective diameter of the lens. This function is routinely abbreviated PSF (point spread function).

The detector is a sufficiently fast optical detector having a two-dimensionally spatially resolving sensor area. In particular, the detector can be a camera, in particular with a CCD, CMOS, sCMOS or SPAD camera chip.

The multi-lens array serves to image light emitted by a sample onto the detector. The lenses of the multi-lens array can be microlenses, in particular, and the multi-lens array can also be referred to as a microlens array.

The lenses of the microlens array need not necessarily all be arranged in the same plane, rather they can also be attached in somewhat different planes. A certain level of defocusing is tolerable, moreover.

In the apparatus according to the invention and in the method according to the invention, the detector can be arranged in a focal plane of at least one lens of the multi-lens array or in the vicinity of the focal plane of at least one lens of the multi-lens array. In particularly preferred variants of the apparatus according to the invention and of the method according to the invention, the detector is arranged in a focal plane of a plurality of lenses, in particular of all of the lenses, of the multi-lens array or in the vicinity of these focal planes.

It is preferred for the detector to be arranged in a focal plane of the lenses of the multi-lens array or in any case in the vicinity of this focal plane. However, that is not absolutely necessary for realizing the present invention. All that is necessary is that the multi-lens array is arranged in a defined and known position relative to the two-dimensionally spatially resolving detector.

The term “control and evaluation unit” denotes all hardware and software components which interact with the components of the microscope according to the invention for the intended functionality of the latter. In particular, the control unit can comprise a computing device, for example a PC, and a camera controller capable of rapidly reading out measurement signals. The computer resources of the control and evaluation unit can be distributed among a plurality of computers and optionally a computer network, in particular also via the Internet. The control and evaluation unit can comprise in particular customary operating equipment and peripherals, such as a mouse, keyboard, screen, storage media, joystick, Internet connection. The control and evaluation unit can read in the image data from the detector, in particular.

The control and evaluation unit can also be used and configured for controlling the light source.

The reconstruction of the three-dimensional images of the examined sample from a recorded image using parameters of the light field arrangement, such as numerical aperture of the microscope objective, total number of illuminated lenses of the multi-lens array, optical parameters of the multi-lens array, settings of the adjustable relay optical unit, can be performed by the control and evaluation unit, but in principle also by some other computing unit.

The back focal plane of the microscope objective and planes optically conjugate thereto are also referred to as pupil planes.

No particular demand is placed on the microscope objective or the microscope objectives. In particular, immersion objectives can be used.

The method according to the invention and the apparatus according to the invention are suitable in principle for any types of samples that are accessible to examination by light field microscopy.

In the apparatus according to the invention, the adjustable relay optical unit is preferably adjustable with respect to at least one of the following parameters:
magnification at which the back focal plane of the microscope objective is imaged into the plane in which the multi-lens array is arranged, or into the vicinity of this plane;
axial position of the back focal plane of the microscope objective to be imaged in the direction of the multi-lens array.

For example, in the adjustable relay optical unit, at least one of the following parameters:
magnification at which the back focal plane of the microscope objective is imaged into the plane in which the multi-lens array is arranged, or into the vicinity of this plane;
axial position of the back focal plane of the microscope objective to be imaged in the direction of the multi-lens array

can be continuously adjustable over at least one range or be adjustable to more than one level.

There is design flexibility with regard to details of the design of the adjustable relay optical unit. For example, the adjustable relay optical unit may comprise at least one optical component of variable focal length, in particular at least one optical component of continuously variable focal length, in particular an optical group of variable focal length.

In a preferred exemplary embodiment, the optical component of variable focal length comprises an interchangeable optical unit or is formed as an interchangeable optical unit, by means of which a plurality of different discrete values of the magnification of the adjustable relay optical unit can be set. The components of the interchangeable optical unit can preferably be dimensioned such that precisely the appropriate magnifications can be set for the microscope objective used or for the microscope objectives used.

More flexible magnification adjustments are possible if the adjustable relay optical unit allows for a continuous variation in magnification. For example, this is achieved if the optical group of variable focal length comprises at least one zoom optical unit or is formed by at least one zoom optical unit. The optical group of variable focal length can also be a single component with variable focal length.

In a particularly preferred variant of the apparatus according to the invention, the adjustable relay optical unit is formed by a lens or a lens group and an optical group of variable focal length, for example a zoom optical unit. Advantageously, the lens can be a tube lens present on a microscope stand in any case. The optical group of variable focal length, e.g. the zoom optical unit, can be connected to a camera flange. In particular, the zoom optical unit can be combined together with the multi-lens array and the camera to form an assembly. However, it is also possible that the tube lens is replaced by the optical group of variable focal length, in particular a zoom optical unit, which then forms the adjustable relay optical unit together with a further lens or lens group arranged downstream in the detection beam path.

In one exemplary embodiment, in which the adjustable relay optical unit is formed by the tube lens of the microscope stand and an optical group of variable focal length, this optical group of variable focal length is part of a plurality of imaging systems.

The first imaging system can be referred to as pupil imaging system. This is the adjustable relay optical unit, present according to the invention. The first imaging system is used to image the back focal plane of the microscope objective into the plane in which the multi-lens array is arranged, or into the vicinity of this plane.

Then there is a total number of image imaging systems that corresponds to the total number of illuminated lenses of the multi-lens array, with each image imaging system being formed by the optical group of variable focal length and a respective lens of the multi-lens array. Using this image imaging system, the intermediate image plane located between the tube lens and the optical group of variable focal length is imaged onto a respective one of the partial images in the plane of the detector of the camera by interaction of the optical group of variable focal length with one of the lenses of the multi-lens array.

In the event that the adjustable relay optical unit is formed by the tube lens of the microscope stand and an optical group of variable focal length, for example a zoom optical unit, the following applies to the respective magnifications: In the event of a change in the setting of the adjustable relay optical unit, such as the zoom optical unit, there is a change in various parameters of the light field recording. Firstly, imaging from the object plane in the sample onto the detector, and hence the camera chip, is characterized by the magnification

$${M}_{tot} = {M}_{1} * {M}_{2}$$

Here, M₁ is the nominal value of the magnification of the microscope objective when using the correct focal length of the tube lens, which in that case corresponds exactly to the magnification of the object plane in the sample into an intermediate image plane downstream of the tube lens. M₂ emerges from a focal length f_{OG} of the optical group of variable focal length, which is part of the adjustable relay optical unit present according to the invention, and the focal length f_{MLA} of the lenses or of one lens of the multi-lens array:

$${M}_{2} = {f}_{MLA} / {f}_{OG}$$

An essential finding is that Nyquist sampling is retained downstream of each lens of the multi-lens array when the zoom is used. This means that the ratio between a lateral spacing of the pixels of the camera chip and the lateral extent of an Airy disk of the PSF of the lenses of the multi-lens array does not change depending on a setting of the zoom optical unit. Thus, the factor of the camera pixel spacing to the Nyquist limit is always the same regardless of the zoom position.

However, due to the modified magnification in the sample, the spacing that can be sampled there and the achievable lateral resolution are modified accordingly. At the same time, the imaged field size, the depth of field, i.e. the depth range of light field imaging, and the achievable resolution in the sample change.

The field size FOV in the sample can be calculated by virtue of imaging the used region of the camera behind a lens of the multi-lens array using the total magnification Mₜₒₜ, according to:

$$F o V = {D}_{camera} / ( N * {M}_{tot} )$$

Here, D_{camera} is a linear extent of the used region of the detector, and hence of the camera chip, and N is the total number of lenses of the multi-lens array along a diameter of the illuminated region of the multi-lens array. A change in a setting of the adjustable relay optical unit, for example a change in a setting of the zoom optical unit, leads to a change in Mₜₒₜ and thus in the imaged field size. For example, a reduction of f_{relay} in a given microscope objective leads to a magnification of Mₜₒₜ and thus to a smaller imaged region of the sample.

The possibility of varying the zoom setting and thus varying the imaging of the back focal plane of the microscope objective onto the multi-lens array can then be used to modify and set the total number of used lenses of the multi-lens array for a given microscope objective and thus for a given diameter of the back focal plane. Let N be the total number of illuminated lenses of the multi-lens array along a diameter of the multi-lens array. Then the lateral resolution of the light field image in the vicinity of the focal plane is reduced by the factor N in comparison with the nominal resolution which is given by the numerical aperture NA_{Objective} of the microscope objective and which would be obtained without using the multi-lens array.

The axial resolution δz_{OP} in the sample plane (Object Plane=OP) can be estimated as follows using the refractive index n of the sample medium, for example an embedding medium, in which the sample is embedded, and the wavelength λ of the light emitted by the sample:

$$δ {z}_{OP} \approx \frac{n λ}{N {A}_{Objective}^{2}} \frac{N}{2} = \frac{N}{2} δ {z}_{Objective}$$

In this case, δz_{Objective} is the axial resolution that would be obtained by the microscope objective without using the multi-lens array.

The axial resolution δz_{OP} is therefore also proportional to the total number N of illuminated lenses of the multi-lens array along a diameter of the image of the back focal plane of the microscope objective in the plane of the multi-lens array.

The axial depth up to which a three-dimensional image of the examined sample can be meaningfully reconstructed from an image measured by a light field arrangement depends on the object-side numerical aperture of the individual lenses of the multi-lens array. Assuming that the entire aperture of the microscope objective is distributed laterally among N lenses, the following approximately applies to the axial depth of the reconstructable volume:

$$DOF \approx \frac{n λ}{N {A}_{Objective}^{2}} {N}^{2}$$

A change in the setting of the adjustable relay optical unit, for example the zoom optical unit, thus leads to a change in the essential parameters of the imaging property of the light field microscope. It is therefore possible within limits to adapt to a sample and to select an advantageous setting for a desired resolution or a desired volume size. Optionally, it may also be possible to combine different recordings of one and the same sample, each recording having been obtained with different settings of the adjustable relay optical unit.

In a further variant, the sample is displaced between the individual exposures with different settings of the adjustable relay optical unit. For example, a relatively small volume with higher resolution can be recorded within a relatively large volume with moderate resolution using the method of light field microscopy, and the measurement data recorded with different settings of the adjustable relay optical unit and different positions of the sample can be fused. The control and evaluation unit can advantageously be used to ensure the scaling of the recorded measurement data.

In advantageous variants of the method according to the invention, the adjustable relay optical unit is set such that the multi-lens array is overexposed. This means that the image of the pupil of the microscope objective in the plane of the multi-lens array is larger than the lateral extent of the multi-lens array, and so portions of the light propagating through the detection beam path are incident in the plane of the multi-lens array radially outside the region in which the lenses are located. For these purposes, the adjustable relay optical unit in the apparatus according to the invention is advantageously dimensioned such that its magnification can be set so that the multi-lens array is overexposed, in particular to different extents.

For example, it may be desirable to optimize the illumination of the multi-lens array in such a way that even lenses of the multi-lens array located at the pupil edge have an insubstantially aberrated point spread function (PSF), in other words do not suffer significant vignetting, over the entire usable axial depth range. For this purpose, it is advantageous if a slight overexposure of the multi-lens array, for example by 5% to 10%, is set by the adjustable relay optical unit.

In other applications, a clearer overexposure of the multi-lens array may be desired. In such a situation, only light from a portion of the entire numerical aperture of the microscope objective reaches the multi-lens array, and hence only a portion of the numerical aperture of the microscope objective is used. As a result, the object-side numerical aperture of the individual lenses of the multi-lens array is reduced, which in turn further increases the depth of field, which is not small in any case on account of the small numerical aperture of the lenses. This allows the reconstructable field depth to be increased, and so thicker samples can be measured without correcting the focus position, optionally even without switching the microscope objective. However, the lateral and axial resolutions also decrease with the reduced object-side numerical aperture.

Then again, it may also be expedient to reduce the illumination of the multi-lens array, in other words to underexpose the multi-lens array. This means that the image of the pupil of the microscope objective is smaller than the lateral extent of the multi-lens array, and so outer lenses in the plane of the multi-lens array are no longer illuminated. This may be desirable if the sample to be examined is thinner than a set reconstructable field depth. By reducing the magnification of the adjustable relay optical unit in such a way that the total number of illuminated lenses of the multi-lens array is reduced, the proportion of the object-side numerical aperture that is attributable to each of the illuminated lenses is increased. This reduces the depth of field and reconstructable field size axially and laterally, while simultaneously increasing lateral and axial resolution.

In these preferred variants of the method according to the invention, a lateral and an axial resolution are thus modified by varying an overexposure or underexposure of the multi-lens array by setting a magnification factor by way of the adjustable relay optical unit. An increase in resolution is accompanied by a reduction in the reconstructable field size and depth of field, and a reduction in resolution is accompanied by an increase in both the reconstructable field size and the depth of field. The apparatus for light field microscopy can thus be adapted to the sample to be examined using the adjustable relay optical unit, in particular using the zoom optical unit.

In an advantageous embodiment of the apparatus according to the invention, the magnification M_{ZO} of the adjustable relay optical unit can be divided into the product of a fixed reference magnification M₀ and a variable magnification Mᵥ, in such a way that

$${M}_{ZO} = {M}_{0} * {M}_{v} .$$

The variable portion of the magnification Mᵥ can now preferably be variable over a range from 1× to 2×, preferably from 0.5× to 4×. In any case, the range of variation from 1× to 2× is sufficient to cover the variation in the pupil diameter of common microscope objectives. A range of variation from 0.5× to 4× moreover allows the resolution and the reconstructable field depth to be set.

In principle, in the apparatus according to the invention for light field microscopy, the functional extensions described above are achieved by the adjustable relay optical unit should only a single microscope objective be present. However, advantageous configurations of the apparatus according to the invention are characterized in that a plurality of different interchangeable microscope objectives are present. Preferably, there can be an interchanger present in that case for switching the microscope objectives, in particular a motorized interchanger, for example with a turret and/or a linear slide. In particular, the interchanger can be controllable by the control and evaluation unit.

In the event of a switch of the microscope objective, there generally also is a change in the axial position of the back focal plane of the respective microscope objective located in the detection beam path and thus also a change in the axial position of planes optically conjugate to this back focal plane. In advantageous configurations of the apparatus according to the invention, an axial position of the plane optically conjugate to the back focal plane of the microscope objective can also be adjusted, in particular adjusted continuously, by the adjustable relay optical unit.

In this case, it is particularly preferable for the axial position of the plane optically conjugate to the back focal plane of the microscope objective to be able to be adjusted by the adjustable relay optical unit in a manner independently of the magnification of the adjustable relay optical unit.

The adjustable relay optical unit can be controllable in particular, i.e. the magnification and/or the axial position of the plane optically conjugate to the back focal plane of the microscope objective can be controlled. For these purposes, the adjustable relay optical unit may have suitable actuators. Advantageously, the control and evaluation unit can be configured to control the adjustable relay optical unit.

In preferred variants of the method according to the invention, the magnification with which the back focal plane of the microscope objective is imaged into the optically conjugate plane and/or the axial position of this optically conjugate plane are set by controlling the adjustable relay optical unit.

The axial position of the multi-lens array can thus be advantageously matched to the axial position of the plane conjugate to the back focal plane of the microscope objective, and a homogeneous and centered illumination of the multi-lens array can be achieved.

The adjustable relay optical unit can be a telecentric relay optical unit in particular. The latter has the advantage that the design of the relay optical unit need not be changed if it needs to be slightly displaced in the axial direction.

In addition to that or in an alternative, it is also possible to displace the multi-lens array and the detector axially in the event of a modified axial position of a pupil plane after the microscope objective was switched. For this purpose, the multi-lens array and the detector can advantageously be combined in an assembly that is displaceable along the optical axis of the detection beam path. There can advantageously be a controllable drive present for displacing this assembly.

The illumination beam path can be configured for wide-field illumination of the sample. The components required to this end are known per se and are not dealt with in detail here.

In addition to that or in an alternative, the illumination beam path can be configured for scanning illumination of the sample, in particular using a light sheet that is inclined relative to the optical axis of the illumination beam path, in a further preferred configuration.

The sample can be illuminated via an optical unit, in particular a microscope objective, which is not part of the detection beam path. For example, this can be a condenser or even a light sheet-like illumination whose direction of propagation either is perpendicular to the optical axis of the detection objective or runs at an angle thereto. In extreme cases, the light sheet can also run parallel to the optical axis of the detection objective. In this case, however, the light sheet typically runs at an angle to the viewing direction of the outer lenses of the multi-lens array.

In an alternative, the sample may be illuminated via the same microscope objective which is also part of the detection beam path.

For these situations, there advantageously is at least one beam splitter present for separating excitation light and detection light, in particular at least one dichroic beam splitter. This beam splitter can also be referred to as a main beam splitter. Advantageously, a plurality of different and interchangeable beam splitters may be present. This is particularly expedient if it should be possible to examine different dyes with different excitation and emission spectra. To this end, in a manner known per se, there can be an interchanger present for changing the beam splitters, in particular a motorized interchanger, for example with a turret and/or a linear slide. Advantageously, dichroic beam splitters having a plurality of excitation and detection bands can also be used.

In a further preferred embodiment of the apparatus according to the invention, the control and evaluation unit is configured for synchronizing a temporally and/or spatially structured illumination with a control of the detector. For example, the control and evaluation unit can synchronize the scanning illumination of the sample using a light sheet with the integration time of the detector.

In principle, the lenses of the multi-lens array can be arranged with any desired distribution or arranged on a grid, for example on a hexagonal or rectangular grid. A rectangular grid can also be referred to as a Cartesian grid.

In principle, the lenses of the multi-lens array can each have the same focal length. However, it may also be advantageous for the multi-lens array to comprise different lenses. For example, at least two of the lenses of the multi-lens array can differ in at least one of the parameters of focal length, diameter, and numerical aperture.

For example, the multi-lens array may comprise a plurality of groups of lenses, wherein the lenses of one group can have the same properties, in particular the same focal length, the same diameter and/or the same numerical aperture.

For example, the lenses of a first group may have a first focal length and/or a first numerical aperture, and the lenses of a second group may have a second focal length and/or a second numerical aperture, which differ from the first focal length and the first numerical aperture, respectively.

It may also be preferable for the multi-lens array to comprise a lens whose numerical aperture is greater than the numerical aperture of further lenses of the multi-lens array. Expediently, the multi-lens array can be designed such that the numerical aperture of a central lens is larger than the numerical aperture of the further lenses of the multi-lens array. For example, the further lenses of the multi-lens array may be arranged in rings around the central lens.

For example, a multi-lens array in which the lenses have different diameters, and hence different numerical apertures, but the same focal length is possible. If the assumption is made that in future there will be camera sensors with for example 100 megapixels and more in the field of scientific imaging as well, then it is for example possible to ensure that the central lens is chosen with a rather large diameter such that for example 2000 by 2000 pixels are available therebehind. The size of the pixels can preferably be chosen such that the PSF of the central lens is sampled approximately at the Nyquist limit. Should the adjustable relay optical unit then be set such that the objective pupil is only imaged on this central lens, normal wide-field imaging with very good resolution but a shallow depth of field and no 3D information can be performed using the apparatus. Thus, only a single sample plane is imaged.

This variant of the method according to the invention is therefore characterized in that the adjustable relay optical unit and/or a variable stop device is or are set such that only one lens of the multi-lens array, in particular a central lens, is illuminated. Wide-field microscopy is realized in this way. Expediently, for this purpose, use can be made of a multi-lens array in which one lens, in particular the central lens, has a numerical aperture that is greater than the numerical aperture of the further lenses.

However, if the adjustable relay optical unit is adjusted in such a way that there also is an illumination of lenses of the multi-lens array that lie radially further to the outside of the central lens and that are arranged, for example, in a ring shape, then simultaneous 3D imaging is achieved in the sense of Fourier light field technology. The sub-images or partial images associated with individual illuminated lenses can then have a different resolution and a depth of field depending on the numerical aperture of the respective lens but can still within certain limits be combined by calculation to form a 3D image. Optionally, the larger lenses can be stopped down such that all subapertures have the same resolution. Since the imaged fields overlap to varying degrees depending on the sizes of the microlenses, it is expedient in that case if there is at least one variable field stop present, which can be set depending on a setting of the adjustable relay optical unit. Specifically, the diameter to which the adjustable cell stop should be set depends on the setting of the adjustable relay optical unit, for example the zoom setting, and the current recording mode. This will also change the size of the propagated field (FoV). However, in this case, it is necessary to accept a loss of light at the multi-lens array on account of the field stop or field stops.

These configurations of the apparatus according to the invention are distinguished in that there is a variable stop device present in the detection beam path upstream of the multi-lens array and serving to set an effective numerical aperture of illuminated lenses of the multi-lens array. For example, the stop device may comprise a controllable liquid crystal device.

In an advantageous variant of the method according to the invention, an effective numerical aperture of the lenses of the multi-lens array is set on an individual basis for at least one lens, in particular a central lens, by a variable stop device.

Embodiments in which the effective numerical aperture can be set on an individual basis for a plurality of lenses or all lenses of the multi-lens array by the variable stop device are particularly preferred.

In a further preferred variant of the method according to the invention, the effective numerical apertures of the lenses of the multi-lens array are set by the variable stop device such that at least some of the lenses, in particular all lenses, have the same effective numerical aperture. This means that the partial images associated with the lenses each have the same resolution and depth of field. This can be advantageous in view of the reconstruction of the three-dimensional volume information. When the same field size is observed in the object, a change in the focal length of the transfer optical unit leads to a change in the sensor-side image size D_{camera, single}

$${D}_{camera , single} = F o V * {M}_{tot} = F o V * {M}_{1} * {f}_{MLA} / {f}_{OG}$$

This means that shortening of the focal length of the adjustable relay optical unit such that ultimately only e.g. the central lens is illuminated leads to the illuminated portion of the camera sensor increasing accordingly. For this reason, it seems advantageous to use a field stop that can be changed e.g. with the zoom of the adjustable relay optical unit in order to avoid overexposure on the one hand when using a plurality of lenses or avoid excessive edge aberrations on the other hand when using the central lens alone. This field stop can also be set by the control unit. In the case of imaging the objective pupil onto for example only the central lens with an increased aperture, it follows from the above, however, that many more pixels than only the pixels arranged directly behind the central lens can be used. For example, 2000×2000 pixels or even significantly more pixels can be used. It is important that zooming down to the central lens of the multi-lens array does not substantially change the total number of illuminated sensor pixels. In extreme cases, the central lens then images a specific field of view onto the whole sensor; i.e. onto e.g. 10 000 by 10 000 pixels if a square 100 megapixel sensor were to be assumed.

The specific properties of the multi-lens array as regards the arrangement of the individual lenses and their focal lengths are included as parameters in the respective algorithms to be used for the reconstruction of the three-dimensional images.

Another advantage of the adjustable relay optical unit is that sampling of the sample in the spatial frequency domain can be increased by recording a plurality of images at in each case different magnification settings of the adjustable relay optical unit.

The positions of the lenses of the multi-lens array in the pupil plane define the spatial frequencies at which the sample to be examined is sampled. Sampling in the spatial frequency domain is incomplete on account of the finite number of lenses and hence the finite total number of parallactic views that can be arranged on the camera chip. As the lateral resolution is chosen to be better, for example by reducing the total number of illuminated lenses of the multi-lens array (underexposure), angular sampling, i.e. sampling in the spatial frequency domain, worsens. In the case of poor angular sampling, deconvolution-based algorithms for reconstructing the three-dimensional volume images tend to produce artefacts.

Sampling in the spatial frequency domain can be varied by varying the magnification at which the back focal plane of the microscope objective is imaged into the plane in which the multi-lens array is arranged. For example, the sample can be sampled over a first grid of spatial frequencies at a first magnification and over a second grid of spatial frequencies at a second magnification, the magnifications being expediently selected such that the first grid and the second grid have no common points (possibly apart from the origin of the coordinate system, which belongs to a central lens of the multi-lens array). Although the angular sampling gaps cannot be closed completely, it is possible to increase the sampling frequency by using different settings of the adjustable relay optical unit while repeatedly capturing images. The volume frame rate decreases here because the images must be recorded in succession.

Therefore, in a preferred variant of the method according to the invention, images are recorded in succession with different settings of the adjustable relay optical unit, in particular with different magnifications, and the image information contained in the images in each case is reconstructed to form a single three-dimensional image. Sampling in the spatial frequency domain can be increased in this way.

In addition to that or in an alternative, sampling in the spatial frequency domain can be increased by recording images of the sample in succession, with the light field propagating in the detection beam path in each case being displaced to different extents transversely, more particularly perpendicular, to the optical axis when the different images are recorded. In this case, the light field is particularly preferably displaced in the detection beam path in two mutually perpendicular directions, in each case transversely, more particularly perpendicular, to the optical axis.

For this purpose, a displacement device, preferably a controllable displacement device, in particular a displacement device controllable by the control and evaluation unit, can advantageously be present in the apparatus according to the invention for displacing the light field propagating in the detection beam path transversely to the optical axis.

For example, an optical element can be introduced into the detection beam path as a displacement device, by means of which the light field can be displaced laterally relative to the optical axis and thus relative to the multi-lens array. As a result thereof, it is also possible to capture intermediate angles that otherwise could not be captured by a fixedly arranged multi-lens array. The more angles can be measured, the better certain artefacts that arise on account of a discrete and poorly sampled angular coordinate can be suppressed. However, since a plurality of images have to be recorded in succession in this case, too, this also leads to an extended recording time and also an extended time for combination by calculation and thus to a reduced volume frame rate.

For example, the displacement device can comprise a plane-parallel plate that is rotatable about an axis that is transverse, more particularly perpendicular, to the optical axis, or rotatable about two axes that are oriented transversely, more particularly perpendicular, to each other and in each case are transverse, more particularly perpendicular, to the optical axis.

In addition to that or in an alternative, the displacement device can be configured for displacing at least one of the lenses of the adjustable relay optical unit, preferably the lens arranged furthest downstream in the detection beam path.

The displacement device expediently comprises at least one linear mechanical actuator, for example a piezo actuator, and/or at least one rotary actuator, which can preferably be actuated by the control and evaluation unit. In this case, the displacements to be achieved need not be greater than half the spacing of the lenses in the multi-lens array.

Instead of or in addition to the displacement of the light field transversely to the optical axis, it would also be possible to displace an assembly consisting of the multi-lens array and the detector transversely to the optical axis. For example, the displacement device for the light field could act in a first coordinate direction, and the assembly having the multi-lens array and the detector could be displaced in the coordinate direction perpendicular thereto, for example by an actuatable piezo actuator.

In a further preferred embodiment of the apparatus according to the invention, the control and evaluation unit is configured to store settings of the adjustable relay optical unit, present when an image is recorded, in particular the focal length, the magnification and/or the axial position of the plane optically conjugate to the back focal plane of the microscope objective, for example in tables (lookup tables). These settings can then be included as parameters in the algorithms used to reconstruct a three-dimensional image from the recorded image.

In principle, the respective control data of the adjustable relay optical unit can be stored for this purpose. However, it is also possible that the currently used settings can be read out for the adjustable relay optical unit, for example by the control and evaluation unit.

In addition to that or in an alternative, the control and evaluation unit in the apparatus according to the invention can be configured, depending on the illumination of the multi-lens array, to determine and store a valid object-side numerical aperture of the individual lenses of the multi-lens array when an image of a sample is recorded. The respective valid object-side numerical aperture is uniquely defined by the degree of illumination, i.e. the underexposure, or the degree of overexposure of the multi-lens array, the numerical aperture of the respective microscope objective used, the geometric arrangement of the lenses of the multi-lens array and the nominal numerical apertures of the lenses of the multi-lens array.

Finally, it may also be advantageous in the apparatus according to the invention if the control and evaluation unit is configured to determine and store a total number of lenses of the multi-lens array that are fully illuminated when an image of a sample is recorded.

In turn, the object-side numerical apertures of the lenses of the multi-lens array and the total number of fully illuminated lenses are included in the algorithms used to reconstruct a three-dimensional image of the sample from the recorded image.

In a further preferred exemplary embodiment of the apparatus according to the invention, the control and evaluation unit is configured, in the event of a switch of the microscope objective, to set the adjustable relay optical unit to values for the focal length, the magnification and/or the axial position of the plane optically conjugate to the back focal plane of the microscope objective that are suitable for the respective microscope objective in the beam path. Instead of making the respective settings directly on the adjustable relay optical unit, the control and evaluation unit can propose advantageous settings to a user for selection.

For example, the magnification of the adjustable relay optical unit can be set by default such that the multi-lens array is slightly overexposed and hence all the lenses of the multi-lens array are fully illuminated. The axial position of the plane optically conjugate to the back focal plane of the microscope objective can then be expediently set such that it lies in the plane of the multi-lens array.

Further advantages and features of the present invention are explained below in connection with the figure.

FIG. 1: shows a schematic exemplary embodiment of an apparatus according to the invention;

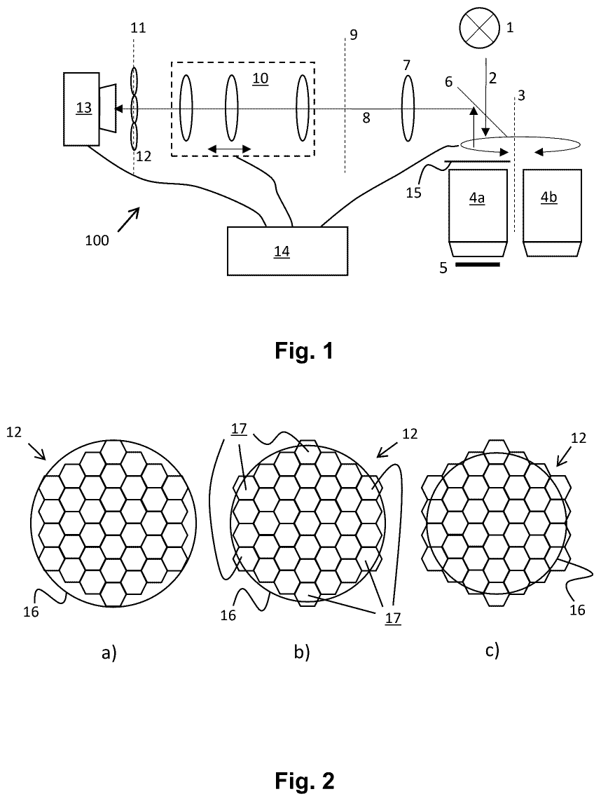

FIG. 2 shows a multi-lens array in three different illumination situations;

FIG. 3: shows an exemplary embodiment of a multi-lens array having different lenses;

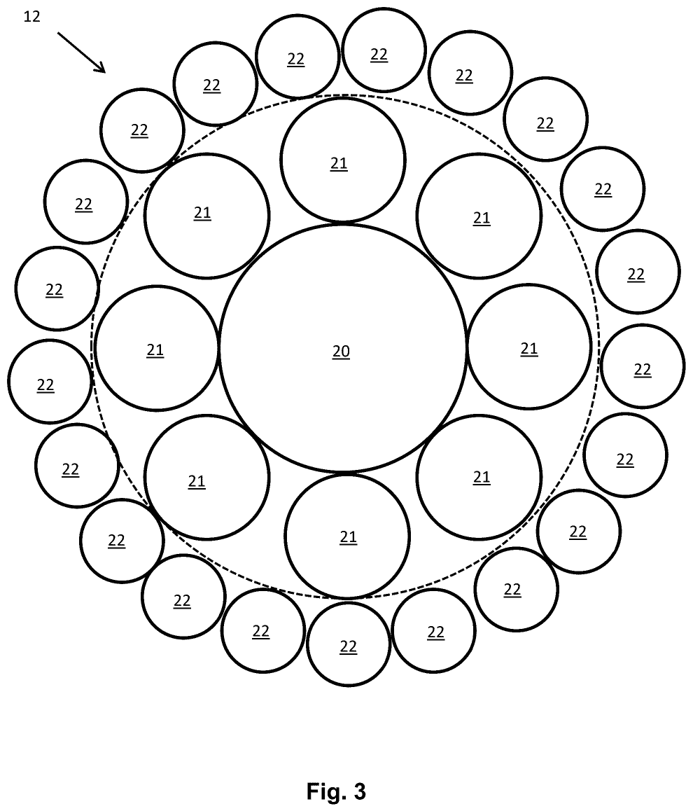

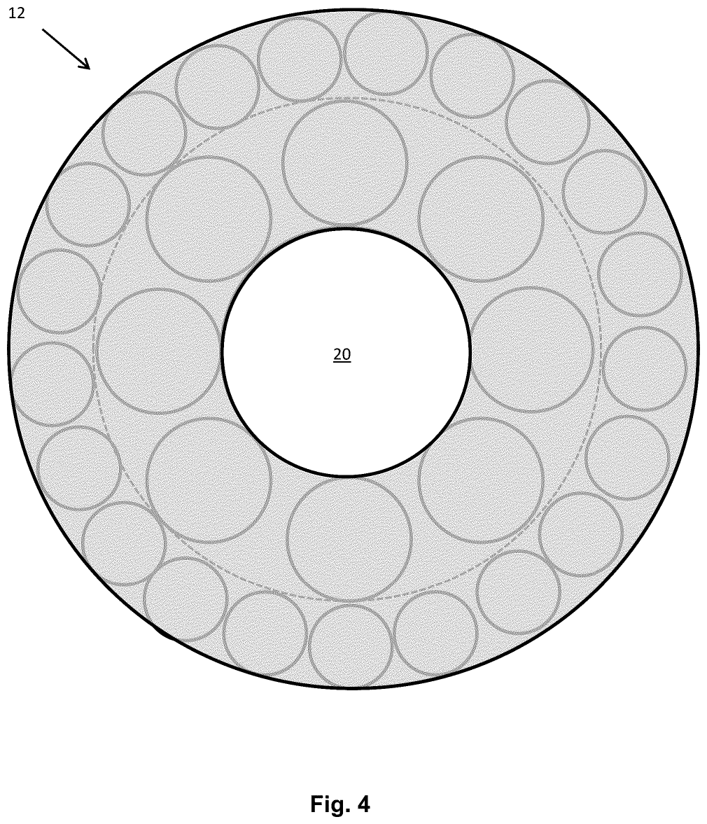

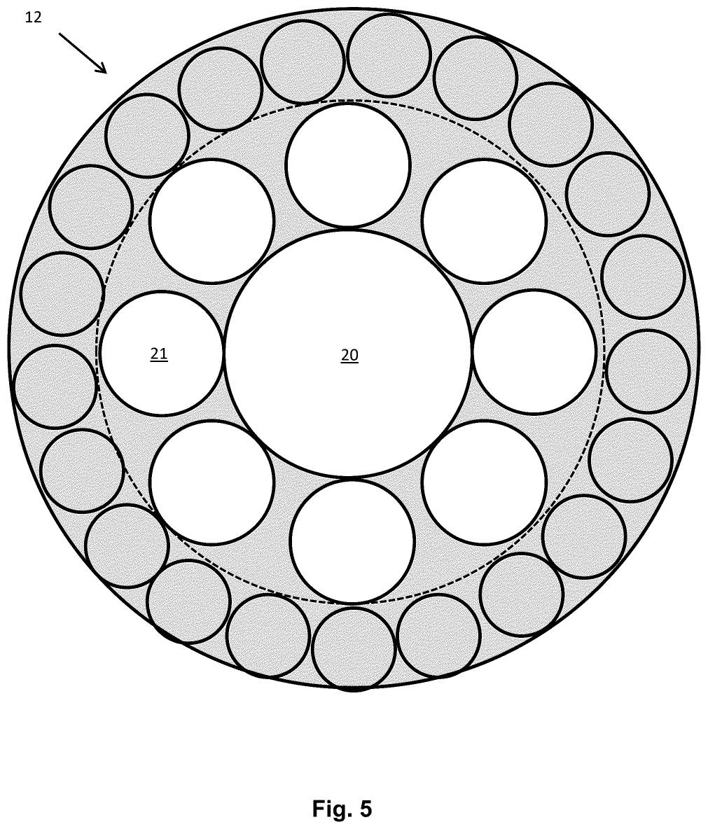

FIG. 4: shows the multi-lens array of FIG. 3 in a first illumination situation;

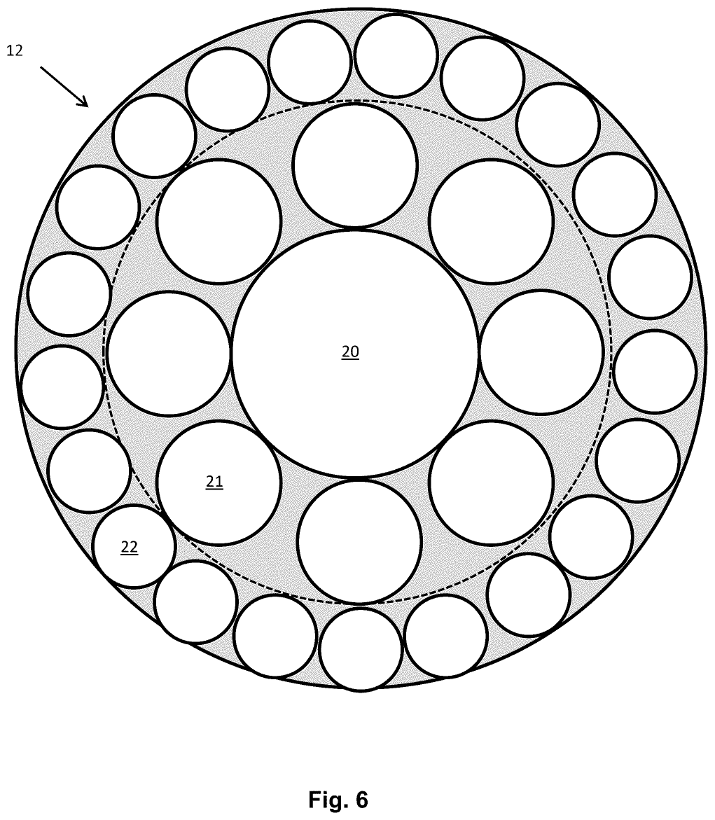

FIG. 5: shows the multi-lens array of FIG. 3 in a second illumination situation;

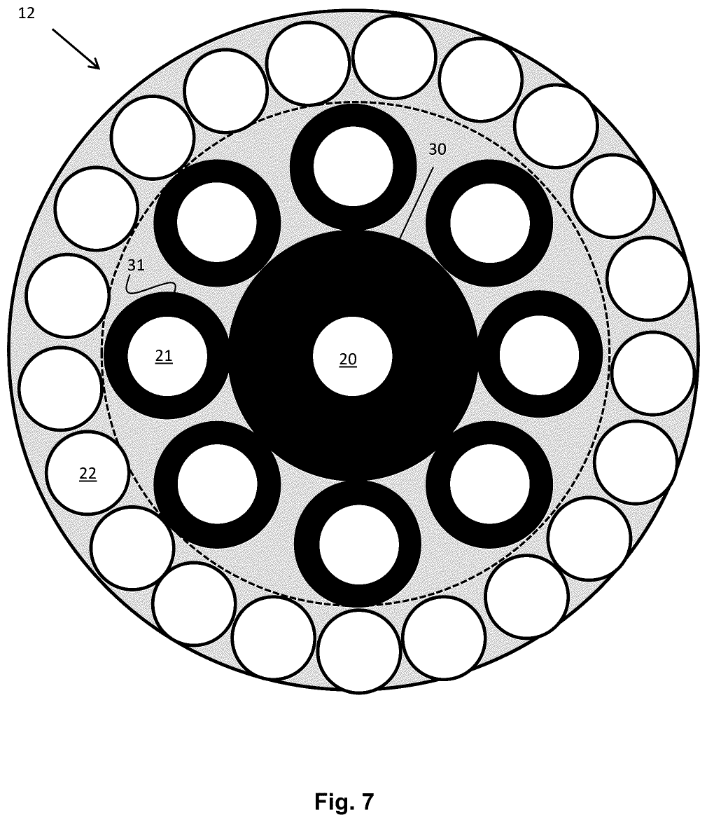

FIG. 6: shows the multi-lens array of FIG. 3 in a third illumination situation;

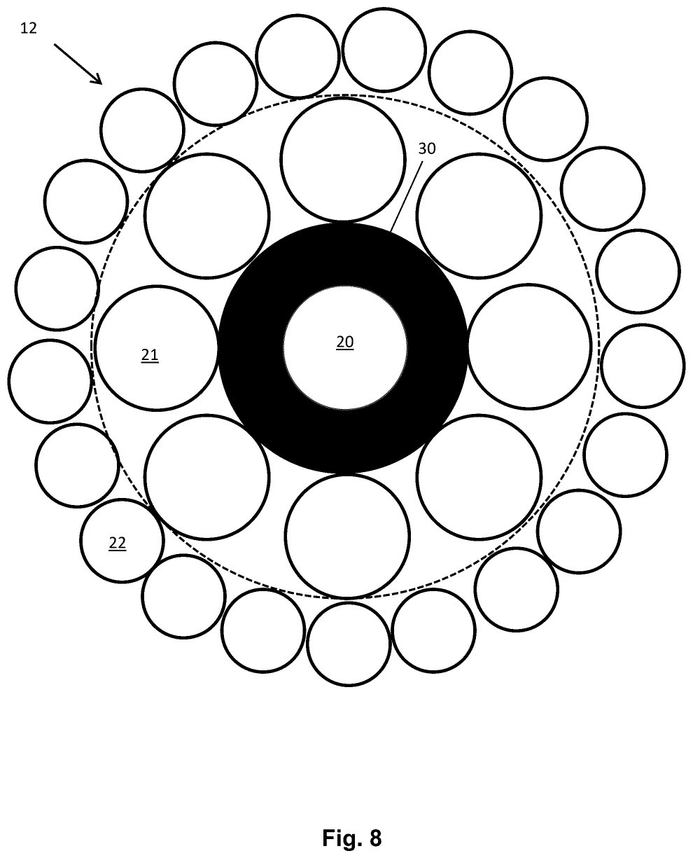

FIG. 7: shows the multi-lens array of FIG. 3 in a fourth illumination situation using a variable stop device; and

FIG. 8: shows the multi-lens array of FIG. 3 in a fifth illumination situation using the variable stop device.

As essential components, the apparatus 100 for light field microscopy shown in FIG. 1 contains a light source 1 for transmitting excitation light, an illumination beam path 2 for guiding the excitation light onto or into a sample 5, a two-dimensionally spatially resolving detector 13 for detecting light emitted by the sample 5 and a detection beam path having a microscope objective 4a and a multi-lens array 12 for imaging the light emitted by the sample 5 onto the detector 13.

The multi-lens array 12 is arranged in a plane 11 optically conjugate to the back focal plane 15 of the microscope objective 4a, or in the vicinity of such a plane 11. The detector 13 is arranged in a focal plane of the multi-lens array 12.

There is a control and evaluation unit 14 present, for example a PC, for controlling the light source 1 and the detector 13 and for evaluating the measurement data from the detector 13. Finally, according to the invention, there is an adjustable relay optical unit present for imaging the back focal plane 15 of the microscope objective 4a into the plane in which the multi-lens array 12 is arranged, or into the vicinity of this plane. In the exemplary embodiment shown in FIG. 1, the adjustable relay optical unit is formed by a tube lens 7 in the detection beam path and a schematically depicted optical system 10 of adjustable focal length, which can also be controlled via the control and evaluation unit 14 in the example shown. The optical system 10 is an optical group of variable focal length. Finally, a motor-driven objective turret not shown in detail is present with a rotation axis 3, by means of which different microscope objectives 4a, 4b can be positioned in the illumination beam path 2 and detection beam path 8. The objective turret can also be controlled via the control and evaluation unit 14.

In the exemplary embodiment shown, the sample 5 is illuminated via the same microscope objective 4a which is also part of the detection beam path 8. In the example of FIG. 1, a dichroic beam splitter 6 is present in order to separate excitation light reflected off the sample 5 from fluorescence that is spectrally redshifted vis-A-vis the excitation light.

The light source 1 provides the excitation light required to illuminate the sample 5 along the illumination beam path 2. The light source 1 can provide wide-field illumination here. However, arrangements in which laser light is either focused or scanned over the sample 5, for example as a light sheet that is tilted relative to the optical axis, may also be preferred. The light emitted by the sample 5, whether by scattering and/or fluorescence emission, is then collimated by the microscope objective 4a and guided via the dichroic beam splitter 6 into the detection beam path 8.

The tube lens 7 creates an image of the sample 5 in an intermediate image plane 9 in the vicinity of a camera flange of the microscope not shown in FIG. 1. The optical system with adjustable focal length 10, which may be a zoom system for example, then creates a plane 11 optically conjugate to the back focal plane 15 of the microscope objective 4a. The multi-lens array 12 is located in this optically conjugate plane 11 or in the vicinity of this plane 11 in any case. The control and evaluation unit 14 can prompt a switch of the microscope objective 4a, 4b and an adjustment of the optical system 10 of variable focal length, and hence of the zoom system, in a manner adapted to the switch of the microscope objective, in particular in automated fashion. When the sample 5 is illuminated, an image can be recorded with the detector 13, and the image data can be recorded by the control and evaluation unit 14 and, if necessary, further processed. In the event of illumination of the sample 5 with a light sheet, a light sheet scan control can also be taken over by the control and evaluation unit 14, in a manner synchronized with the exposure time of the detector 13. This is fundamentally known and not described in detail here.

If necessary, the control and evaluation unit 14 can also carry out the reconstruction of the three-dimensional images of the sample 5 from the images measured by the detector 13. However, this can also be performed by a powerful computing unit that is not shown and, in particular, located at a different location.

In FIG. 2, a hexagonal grid of a multi-lens array 12 with 37 hexagonal cells is shown at each of a), b) and c). Each of the individual hexagonal cells contains a respective lens. For example, the 37 lenses can all be identical.

Reference sign 16 in each case represents the outer boundary of the region of the multi-lens array 12 illuminated via the detection beam path. It is evident that the illuminated region 16 becomes ever smaller from a) to c). This is achieved in each case by different settings of the adjustable relay optical unit present according to the invention.

In detail, all hexagonal cells are fully illuminated in partial image a). The multi-lens array 12 is slightly overexposed, and so some of the light is lost. The light efficiency thus is not optimal.

Partial image b) shows a situation in which the light coming from the microscope objective 4a is incident on the multi-lens array 12 almost in full. The light efficiency thus is almost optimal here.

Partial image c) depicts a situation in which the light coming from the microscope objective 4a is incident on the multi-lens array 12 in full. Thus, the light efficiency is maximal here as well. However, some lenses 17 at the edge of the multi-lens array 12 are illuminated incompletely, specifically with only approximately 25% of the light that is incident on the fully illuminated inner lenses. The point spread functions associated with these not fully illuminated lenses 17 thus obtains an elliptical cross section.

FIG. 3 schematically shows one example of a multi-lens array 12 in which the lenses are not all identical. Specifically, there is firstly a central lens 20 present having a comparatively large diameter and a large numerical aperture. Around the central partial lens 20, eight identical middle lenses 21 are arranged on a first ring, and their diameter is approximately equal to half that of the central lens 20. Respectively identical outer lenses 22 are then arranged on an outer ring, and their diameter is in turn approximately equal to half that of the middle lenses 21. Advantageously, all the lenses 20, 21 and 22 have the same focal length. The numerical aperture of the outer lenses 22 is less than that of the middle lenses 21. The numerical aperture of the middle lenses 21 is less than that of the central lens 20.

Different settings of the adjustable relay optical unit present according to the invention, and hence variations in the illuminated region of the multi-lens array 12, allow for different numbers of lens rings to be illuminated, for example only the central lens 20, the central lens 20 together with the middle lenses 21 or all lenses 20, 21 and 22. This allows for normal wide-field imaging and different variants of Fourier light field imaging. Examples thereof will be explained in connection with FIGS. 4 to 8.

Only the inner lens 20 is illuminated in the situation depicted in FIG. 4, i.e. the pupil of the microscope objective 4a is only imaged on the central lens 20. This results in normal wide-field imaging.

In the example of FIG. 5, the adjustable relay optical unit is set such that the central lens 20 and the middle lenses 21 are illuminated. This allows for Fourier light field imaging with a certain depth of field and optical resolution. In this case it should be noted that, in comparison with the partial images associated with the middle lenses 21, the depth of field in the partial image associated with the central lens 20 is shallower but its optical resolution is greater on account of its greater numerical aperture. The different parameters of the central lens 20 in comparison with those of the middle lenses 21 must be taken into account when reconstructing the three-dimensional volume information from the total of nine partial images.

Finally, in the situation depicted in FIG. 6, the adjustable relay optical unit is set such that the central lens 20, the middle lenses 21 and the outer lenses 22 are illuminated. Here, too, Fourier light field imaging is realized, with an increased depth of field but a poorer optical resolution in comparison with the situation in FIG. 5. The reason for this lies in the fact that the portions of the total aperture of the microscope objective 4a in each case attributable to the individual lenses 20, 21, 22 are smaller in the situation in FIG. 6 than in the situation in FIG. 5. The detection-side apertures for each lens 20, 21 22 are therefore lower than in the illumination situation in FIG. 5.

The situation in FIG. 7 differs from that in FIG. 6 in that the illumination of the central lens 20 and of the middle lenses 21 is curtailed by means of a variable stop device (not depicted in the figures), for example a liquid crystal device, in such a way that all lenses that are at least partly illuminated each have the same effective detection-side numerical aperture. The illuminated regions of the inner lens 20 and of the middle lenses 21 are thus set such that they are the exact same size as for the outer lenses 22. This realizes Fourier light field imaging in which all partial images have the same optical resolution and the same depth of field. This is advantageous in view of the reconstruction of the three-dimensional volume information. However, this advantage is accompanied by the loss of stopped down light. Other variants are also possible in this case, for example in such a manner that the outer lenses 22 have a smaller detection-side aperture than the central lens 21 and/or the middle lenses 21.

The latter is shown in FIG. 8 in which only the aperture of the central lens 20 is curtailed by means of the variable stop device, in such a way that the central lens 20 and the middle lenses 21 have the same detection-side aperture. This means that the partial images associated with the central lens 20 and the middle lenses 21 have the same optical resolution and depth of field. By comparison, the depth of field is higher, but the optical resolution is lower in the partial images associated with the outer lenses 22, this being due to their reduced detection-side aperture in comparison with the central lens 20 and the middle lenses 21.

### LIST OF REFERENCE SIGNS

1 Light source
2 Illumination beam path
3 Axis of rotation of an objective turret
4a Microscope objective
4b Microscope objective
5 Sample
6 Dichroic beam splitter
7 Tube lens
8 Detection beam path
10 Zoom optical unit, optical group of variable focal length
11 Plane optically conjugate to the back focal plane 15 of the microscope objective 4a, 4b
12 Multi-lens array
13 Detector
14 Control and evaluation unit
15 Back focal plane of the microscope objective 4a, 4b
16 Boundary the illuminated region of the multi-lens array 12
17 Lenses 17 of the multi-lens array 12 that are not fully illuminated
20 Central lens of the multi-lens array 12
21 Middle lenses of the multi-lens array 12
22 Outer lenses of the multi-lens array 12
30 Stopped down region of the lens 20 of the multi-lens array 12
31 Stopped down region of the lens 21 of the multi-lens array 12
100 Apparatus according to the invention

1. An apparatus for light field microscopy, comprising:
a light source for transmitting excitation light,
an illumination beam path for guiding the excitation light onto or into a sample,
a two-dimensionally spatially resolving detector for detecting light emitted by the sample,
a detection beam path containing at least one microscope objective and containing at least one multi-lens array for imaging the light emitted by the sample onto the detector,
the multi-lens array being arranged in a plane optically conjugate to the back focal plane of the microscope objective, or in the vicinity of such a plane,
a control and evaluation unit for controlling the detector and for evaluating the measurement data from the detector, and
an adjustable relay optical unit for imaging the back focal plane of the microscope objective into the plane in which the multi-lens array is arranged, or into the vicinity of this plane.

2. The apparatus as claimed in claim 1,
wherein the detector is arranged in a focal plane of at least one lens of the multi-lens array or in the vicinity of the focal plane of at least one lens of the multi-lens array.

3. The apparatus as claimed in claim 1,
wherein the adjustable relay optical unit is adjustable with respect to at least one of the following parameters:
magnification at which the back focal plane of the microscope objective is imaged into the plane in which the multi-lens array is arranged, or into the vicinity of this plane;
axial position of the back focal plane of the microscope objective to be imaged in the direction of the multi-lens array.

4. The apparatus as claimed in claim 1,
wherein the adjustable relay optical unit comprises at least one optical component of variable focal length.

5-7. (canceled)

8. The apparatus as claimed in claim 1,
wherein a magnification of the adjustable relay optical unit is adjustable such that the multi-lens array is overexposed or underexposed.

9. (canceled)

10. The apparatus as claimed in claim 1,
wherein the axial position of the plane optically conjugate to the back focal plane of the microscope objective can be adjusted by the adjustable relay optical unit in a manner independently of the magnification of the adjustable relay optical unit.

11. The apparatus as claimed in claim 1,
wherein the adjustable relay optical unit is a telecentric relay optical unit.

12. The apparatus as claimed in claim 1,
wherein an assembly formed by the detector and the multi-lens array is displaceable along the optical axis of the detection beam path.

13. The apparatus as claimed in claim 1,
wherein the illumination beam path is configured for wide-field illumination of the sample.

14. The apparatus as claimed in claim 1,
wherein the illumination beam path is configured for scanning illumination of the sample.

15-19. (canceled)

20. The apparatus as claimed in claim 1,
wherein there is a displacement device present for displacement transversely to the optical axis of the light field propagating in the detection beam path.

21-23. (canceled)

24. The apparatus as claimed in claim 1,
wherein the control and evaluation unit is configured to store settings of the adjustable relay optical unit present when an image is recorded.

25. The apparatus as claimed in claim 1,
wherein the control and evaluation unit is configured, depending on the illumination of the multi-lens array, to determine and store a valid object-side numerical aperture of the individual lenses of the multi-lens array when an image of a sample is recorded.

26. The apparatus as claimed in claim 1,
wherein the control and evaluation unit is configured to determine and store a total number of lenses of the multi-lens array that are fully illuminated when an image of a sample is recorded.

27. The apparatus as claimed in claim 1,
wherein the control and evaluation unit is configured, in the event of a switch of the microscope objective, to set the adjustable relay optical unit to values for the magnification and/or the axial position of the plane optically conjugate to the back focal plane of the microscope objective that are suitable for the respective microscope objective located in the beam path.

28. The apparatus as claimed in claim 1,
wherein the multi-lens array comprises different lenses.

29. The apparatus as claimed in claim 1,
wherein there is a variable stop device present in the detection beam path upstream of the multi-lens array and serving to set an effective numerical aperture of illuminated lenses of the multi-lens array.

30. A method of light field microscopy, comprising:
irradiating a sample with excitation light,
imaging light emitted by the sample via a microscope objective and a multi-lens array onto a two-dimensionally spatially resolving detector,
the multi-lens array being arranged in a plane optically conjugate to the back focal plane of the microscope objective, or in the vicinity of such a plane, and
wherein a three-dimensional image of the sample is reconstructed from an image recorded by the detector,
wherein the back focal plane of the microscope objective is imaged by an adjustable relay optical unit with variable magnification into the plane in which the multi-lens array is arranged, or into the vicinity of this plane.

31. The method as claimed in claim 30,
wherein a lateral resolution, an axial resolution, a reconstructable field size and a depth of field are set by adjusting a magnification of the adjustable relay optical unit.

32-33. (canceled)

34. The method as claimed in claim 30,
wherein images are recorded in succession with different settings of the adjustable relay optical unit, and
wherein the image information contained in the images in each case is reconstructed to form a single three-dimensional image.

35. The method as claimed in claim 30,
wherein, in order to increase the sampling of the sample in the spatial frequency domain, images of the sample are recorded in succession, with the light field propagating in the detection beam path in each case being displaced to different extents transversely to the optical axis when the different images are recorded.

36. The method as claimed in claim 30,
wherein, in the event of a switch of the microscope objective, values for the magnification and/or the axial position of the plane optically conjugate to the back focal plane of the microscope objective are offered to a user for selection and/or automatically adjusted in the adjustable relay optical unit.

37. The method as claimed in claim 30,
wherein an effective numerical aperture of the lenses of the multi-lens array is individually set for at least one lens by a variable stop device.

38. The method as claimed in claim 30,
wherein the effective numerical apertures of the lenses of the multi-lens array are set by the variable stop device such that at least some of the lenses have the same effective numerical aperture.

39. The method as claimed in claim 30,
wherein the adjustable relay optical unit and/or the variable stop device is set such that only one lens of the multi-lens array is illuminated.
